(19) United States
(12) Patent Application Publication
(10) Pub. No.: US 2012/0296768 A1
(43) Pub. Date: Nov. 22, 2012

(54) METHOD AND SYSTEM FOR MOTIVATING CONSUMERS AWAY FROM IMPULSE SPENDING

(75) Inventors: Phillip FREMONT-SMITH, Belmont, MA (US); John MILEHAM, Somerville, MA (US)

(73) Assignee: IMPULSESAVE, INC., Belmont, MA (US)

(21) Appl. No.: 13/108,478

(22) Filed: May 16, 2011

(51) Int. Cl. G06Q 40/00; G06Q 30/00

(52) U.S. Cl. 705/26.8; 705/42; 705/26.1

(57) ABSTRACT

A system includes a computer-implemented method of motivating users toward at least one constructive financial alternative to spending. The method includes receiving, at a server, from a user at a first consumer device, an initial configuration for at least one financial goal, wherein the configuration includes a goal name and a target amount representing a financial value associated with the at least one constructive financial alternative to spending; receiving, at the server, from the user at a second consumer device after the initial configuration is complete, an electronic command directing potential application of funds of a given amount benefiting the at least one financial goal, representing a choice from among a plurality of spending options integrated into the user's lifestyle and spending patterns.

### TECHNICAL FIELD

The present method and system relate to consumer financial transactions, and more particularly to a system and techniques to motivate consumers away from impulse spending toward a more constructive set of options for financial transactions otherwise not accessible during the thrill of spending.

### BACKGROUND

Today too many consumers will not have sufficient financial assets on which to retire, and they know it, yet they continue to spend beyond their means. Additionally, the majority of consumers feel that much of their paycheck slips through their fingers and feel they should be putting their money to better uses, yet habitually they do not. Consumers live in a social norm and culture that funnels or herds consumers toward impulse purchases. In retail locations such as clothing stores and supermarkets, everything from the physical property layout to aisle displays beckon and entice consumers to spend increasing amounts of income on unnecessary products or items. While shopping online, web sites incentivize impulse purchases by showing consumers products they looked at but did not buy last time, products that their friends have bought, and additional products that other purchasers of the same item have also bought.

As one method to encourage consumers away from spending, current financial systems allow users to configure timed automatic savings plans. Consumers use a web site, often at a financial institution, to pre-configure a timed schedule to withdraw funds from an origin financial account and deposit the funds into a separate destination financial account automatically.

The problem with such savings plans is that they are limited in that the only alternative offered is saving. Additionally, such savings plans require the user to remember to configure the financial transaction in the first place. Furthermore, timed automatic savings plans deduct a pre-configured amount from the origin financial account. However, a consumer might have different needs and ability to save from one month to the next. Because such plans are pre-configured, they are not sufficiently flexible to adjust the amount of savings according to the user's current needs or desires, as circumstances may change week to week, or even day to day. In addition, the only encouragement offered by timed automatic savings plans is the ability for the user to see the balance increasing in a destination financial account, perhaps supplemented by a graphical progress bar. However, there is no additional ongoing incentive, feedback, or encouragement for the user to continue to save.

What is needed is a way to motivate consumers towards more constructive uses for their money, in the same manner in which they live and would normally spend, on whim or impulse. While most consumers make impulse purchases, the present system and techniques are directed to providing a new set of transactional options: impulse transactions. What is needed is a system and techniques of encouragement and incentives integrated into the consumer's existing purchasing and spending lifestyle, to be as natural and easy to apply money constructively on impulse as it is to spend on impulse.

### BRIEF DESCRIPTION OF THE DRAWINGS

The following figures are provided for the purpose of illustration only and are not intended to be limiting. The example embodiments may be more fully understood by reference to the detailed description, in conjunction with the following figures, wherein:

FIG. 1 is an exemplary embodiment of a system of the present invention.

FIG. 2 is a block diagram of the system of the present invention.

FIG. 3 is a flow diagram of an exemplary process of shopping at retail in the present system.

FIG. 4 is a flow diagram of an exemplary process of parsing SMS text messages in the present system.

FIG. 5 is an exemplary embodiment of user interaction with the present system while shopping online.

FIG. 6 is a flow diagram of an exemplary process of shopping online in the present system.

FIG. 7 is an exemplary embodiment of user interaction with the present system while creating a financial goal.

FIG. 8 is a flow diagram of an exemplary process of creating a financial goal in the present system.

FIG. 9 is an exemplary embodiment of a user interaction with the present system while creating an impulse transaction.

FIG. 10 is a flow diagram of a process of creating an impulse transaction in the present system.

FIG. 11 is an exemplary embodiment of a user interaction with the present system visualizing progress in financial goals.

FIG. 12 is an exemplary embodiment of a user interaction with the present system showing impulse transactions from the user community at large of the present system.

FIG. 13 is an exemplary embodiment of a user interaction with configuring social privacy settings in the present system.

### Like reference numbers and designations in the various drawings indicate like elements.

### SUMMARY

The present system and techniques motivates consumers away from impulse spending and provides a new set of financial options otherwise inaccessible in the moment.

One aspect of the system includes a computer-implemented method of motivating users toward at least one constructive financial alternative to spending. The method includes receiving, at a server, from a user at a first consumer device, an initial configuration for at least one financial goal, wherein the configuration includes a goal name and a target amount representing a financial value associated with the at least one constructive financial alternative to spending; receiving, at the server, from the user at a second consumer device after the initial configuration is complete, an electronic command directing potential application of funds of a given amount benefiting the at least one financial goal, representing a choice from among a plurality of spending options integrated into the user's lifestyle and spending patterns.

In some embodiments, the computer-implemented method further includes the step of sending, to interested participants, electronic notifications configured to motivate participation toward achieving the at least one financial goal. In a further embodiment, the interested participants include the user himself or herself, or others designated by the user as interested in encouraging or incentivizing the user to contribute financially to the at least one financial goal.

In some embodiments, the electronic command also receives instructions from the user directing the server to (1) apply an amount related to a potential shopping purchase toward a more constructive use, in a manner integrated into the potential shopping purchase, (2) apply an amount toward a more constructive use independent of any potential shopping purchase, (3) request feedback or encouragement about the potential purchase from others in the user's social community, or (4) add the potential purchase to a wish list.

Other features and advantages of the system and techniques of the present invention will be apparent from the following description.

### DESCRIPTION OF EXAMPLE EMBODIMENTS

### Overview

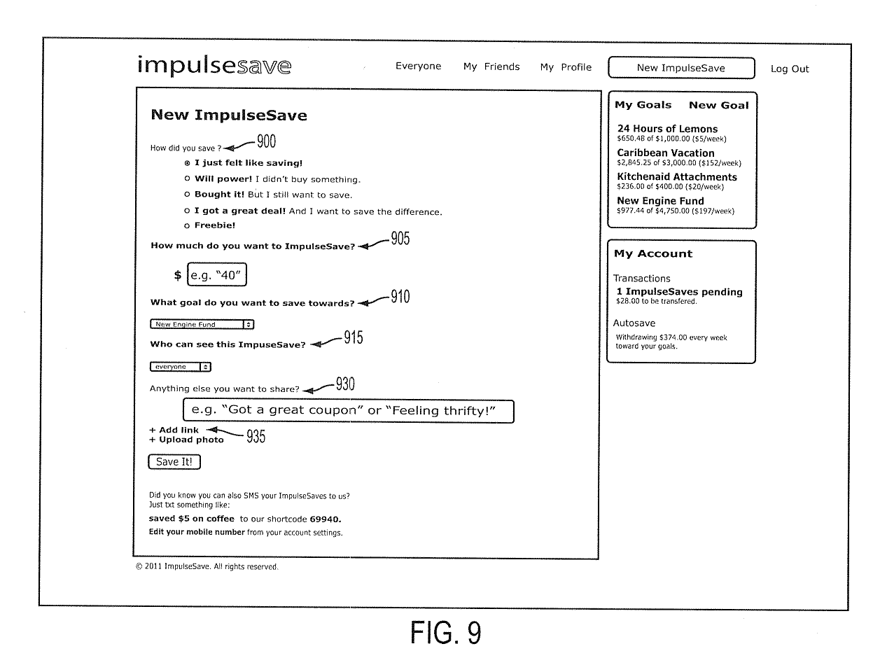

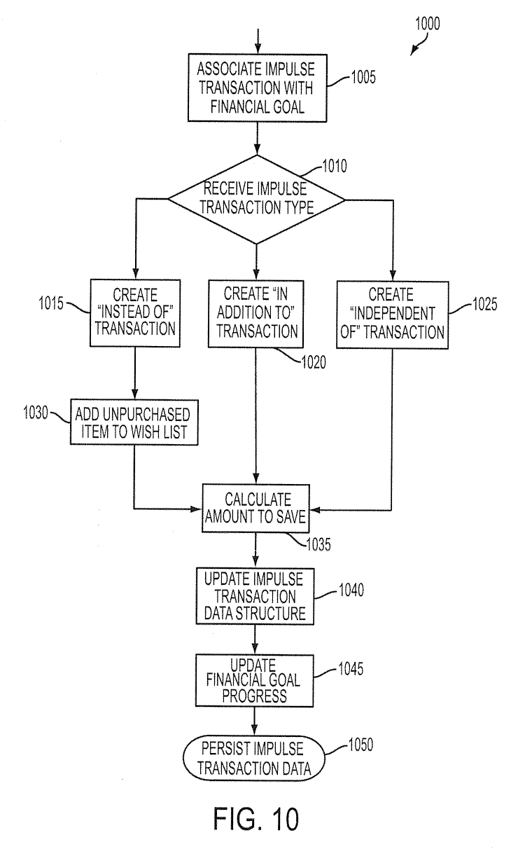

The present system is configured to allow a consumer to create impulse transactions. Impulse transactions represent ways to leverage the user's existing behavior and lifestyle in which he or she would normally spend money, and to motivate the user to apply those funds toward a more constructive financial use, such as savings. Impulse transactions are transactions which a user may create in the course of using exemplary embodiments of the present system and techniques. In exemplary embodiments, impulse transactions arise during the consumer's shopping experience, either retail or online. In other exemplary embodiments, impulse transactions also arise independent of, or entirely unrelated to, the consumer's shopping experience. Impulse transactions are described in further detail in FIGS. 9-10.

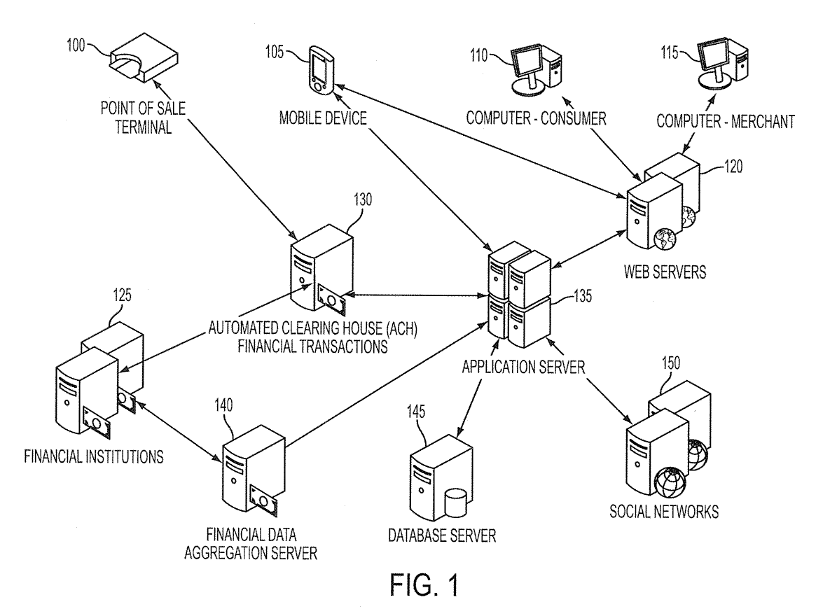

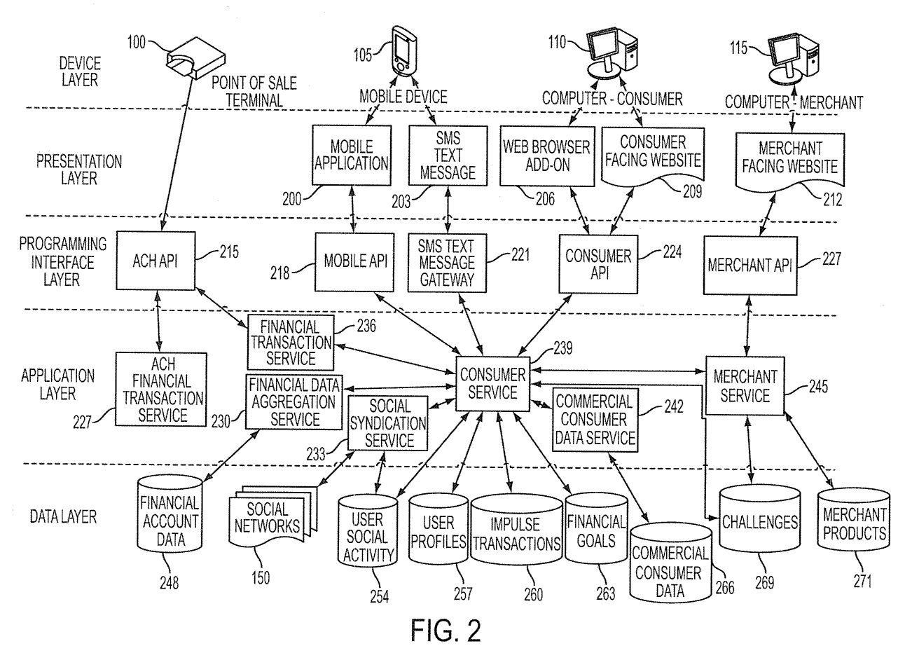

As shown in FIG. 1, an exemplary system of the present invention includes an application server 135 in communication with web server 120, database server 145, social networking communities 150, financial transactions server 130, and financial data aggregation server 140. One of skill in the art will recognize that any of these servers may be duplicated and, similarly, may be in communication with duplicate servers to improve performance, for example via load-balancing methods. As shown in FIG. 2, web server 120 displays web sites 209, 212 for consumer devices 110, 115 to provide input to application server 135. Similarly, mobile device 105 provides input to application server 135 through mobile application 200, web site 209, or SMS text message 203. Application server 135 also receives indirect information regarding the user's spending behavior from Point Of Sale terminal 100 via financial transactions server 130.

FIG. 2 provides more detail regarding the system of FIG. 1. An exemplary system of the present invention includes a set of processing devices linked through a presentation layer and programming interface layer to a consumer service 239 running in an application layer. A consumer service is a module or collection of modules that implements the computer-implemented methods described herein.

In multi-tiered web application architectures, consumer service 239 makes method and procedure calls to other modules through a set of application programming interfaces (APIs) 215, 218, 224, 227. In this manner, one of skill in the art has design flexibility to modify the process implementations defined in consumer service 239 without having to modify the APIs used by consumer devices 100, 105, 110, 115 in the device layer, and without having to modify the processes themselves running in user interfaces 200, 206, 209, 212.

Similarly, consumer service 239 makes procedure or method calls to other services defined in the application layer. Using other services such as financial data aggregation service 230, social syndication service 233, financial transaction service 236, or commercial consumer data service 242 provides a layer of abstraction to consumer service 239. Services 230, 233, 239, 242 provide method interfaces that allow a calling process to create, read, update, or delete records in datastores 248, 254, 257, 260, 263, 266, 269, 271. One of skill in the art is able therefore to change the structure of any underlying datastore, or switch datastore vendors, without having to modify any of the calling processes that use services 230, 233, 239, 242, 245 to access the datastores.

A consumer is able to use many different devices to access consumer service 239. This description refers to consumers alternatively as users. Exemplary devices include mobile device 105 and computer 110.

Consumer service 239 is further linked to a group of datastores 248, 254, 260, 263, 266, 269, 271. In some embodiments, datastore 248 represents financial account data, datastore 254 represents user social activity, datastore 257 represents user account profiles, datastore 260 represents impulse transactions, datastore 263 represents financial goals, datastore 266 represents commercial consumer data, datastore 269 represents challenge data, and datastore 271 represents merchant product data.

In typical web application architecture, each datastore may often be implemented as a table in a database. Although this example embodiment shows separate datastores, one of skill in the art will recognize that in other embodiments one or more of the datastores may be combined, and still other embodiments may include additional datastores.

As described above, commercial consumer data datastore 266 provides information to and receives information from commercial consumer data service 242. Commercial consumer data service 242 provides a layer of abstraction by defining procedures and methods to allow calling processes to access the information stored in commercial consumer data datastore 266.

Automated Clearing House (ACH) Financial Transaction Service provides an ACH API 215 to process ACH financial transactions. Example financial transactions include direct deposit of payroll; Social Security and other government payments; federal, state, and local tax payments and refunds; direct debit payment of consumer bills such as mortgages, loans, utilities, insurance premiums, rents, and other regular payments; business-to-business payments; and electronic commerce payments. Financial transaction service 236 allows consumer service 239 to create, read, update, or delete financial transactions.

Similarly, financial account datastore 248 provides information to and receives information from financial data aggregation service 230. In some embodiments, financial data aggregation service 230 is used to query a user's financial accounts, for example for balances, transaction history, or interest rate. In further embodiments, financial data aggregation service 230 also interfaces directly with private APIs from partner financial institutions 125.

One of skill in the art will recognize that, especially with sensitive financial data, financial datastore 248, financial services 230, 236, and ACH service 227 may be hosted on separate physical servers from consumer service 239 to provide better security, privacy, and isolation of consumers' sensitive financial information.

User social activity datastore 254 is linked to one or more social network communities 150, such as Facebook® or Twitter®, through syndication service 233. In some embodiments, syndication service 233 uses social networking APIs offered by social network communities 150 to retrieve information about the user's social network community. In this manner, syndication service 233 provides a layer of abstraction to calling processes if the structure of social activity datastore 254 changes, or if third party social network communities 150 modify their APIs. Example information retrieved by syndication service 233 includes social profiles, friend lists, or status updates. Consumer service 239 also allows users to maintain separate social networks specific to the general user community of the present system, presented through web site 209 or mobile application 200. Therefore, syndication service 233 uses social activity datastore 254 to store mappings between users' social community on consumer service 239, and social network communities 150.

Consumer facing web site 209 uses consumer API 224 to make programming calls to consumer service 239 in response to the consumer's input. Similarly, merchant facing web site 212 uses merchant API 227 to make programming calls to merchant service 245 in response to merchants' input.

Example mobile devices 105 include smart phones, personal data assistants (PDAs), and tablet computers. Mobile device 105 includes a display, processor, memory, and non-volatile storage. Mobile device 105 is operable to execute an operating system and mobile application (app) 200.

Consumers and merchants can access consumer or merchant facing web sites 209, 212 using, for example, personal computers 110, 115. In some embodiments, personal computers 110, 115 include a display, processor, memory, and non-volatile storage. Personal computers 110, 115 are operable to execute an operating system and Internet browser. In further embodiments, the Internet browser includes browser add-on 206 configurable to use consumer service 239 through consumer API 224. Browser add-on 206 is described in more detail below.

In alternative embodiments, mobile device 105 accesses web site 209 through an appropriate mobile web browser.

Consumer service 239 and its associated processes are configured to receive profile information from the user to create an online account associated with the user's personal identifying information including at least name, username, location, or email address. Consumer service 239 further allows the user to configure an online profile within this online account.

### Retail Example Product Purchase

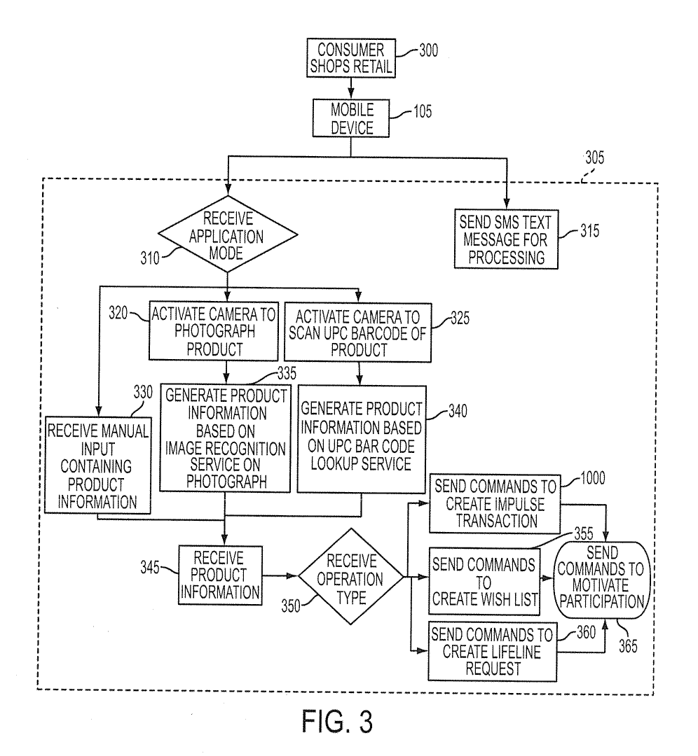

As shown in FIG. 3, in some embodiments as a consumer is shopping at a retail site 300, the consumer uses a consumer device such as mobile device 105 to interact with the present system and techniques. In exemplary embodiments, mobile device 105 allows consumers to use mobile application 200, or SMS text messages 203.

If mobile device 105 has mobile application 200 installed, the consumer elects to use mobile application 200. In step 310, mobile application 200 receives an application mode from the consumer. For example, mobile application 200 may allow the consumer to (1) enter a transaction manually in step 330, (2) photograph a product of interest in step 320 using a camera built in to mobile device 105, or (3) scan the UPC barcode of a product of interest in step 325 using a camera built in to mobile device 105.

In step 330, mobile application 200 or web site 209 receives data which is input manually from the consumer regarding the product of interest.

In other embodiments, in step 320, mobile application 200 allows the user to photograph an item instead of entering product information manually. In step 335, mobile application 200 uses an online image recognition service to retrieve product information using the photograph as input.

In alternative embodiments, in step 325, mobile application 200 allows the user to scan an item's barcode with a camera built in to mobile device 105 instead of entering product information manually. In step 340, mobile application 200 retrieves the item's information via its barcode from a barcode retrieval online service.

In step 345, consumer service 239 receives the input product information via manual user entry through web site 209 or mobile application 200 in step 330, or generated in step 335 from photograph taken in step 320, or generated in step 340 from barcode scanned in step 325 from mobile application 200. In step 350, mobile application 200 receives a desired operation type from the consumer and uses the input product information from step 345 to create an impulse transaction in process 1000, wish list in step 355, or lifeline request in step 360 using consumer service 239. Impulse transactions, wish lists, and lifeline requests are described in further detail below.

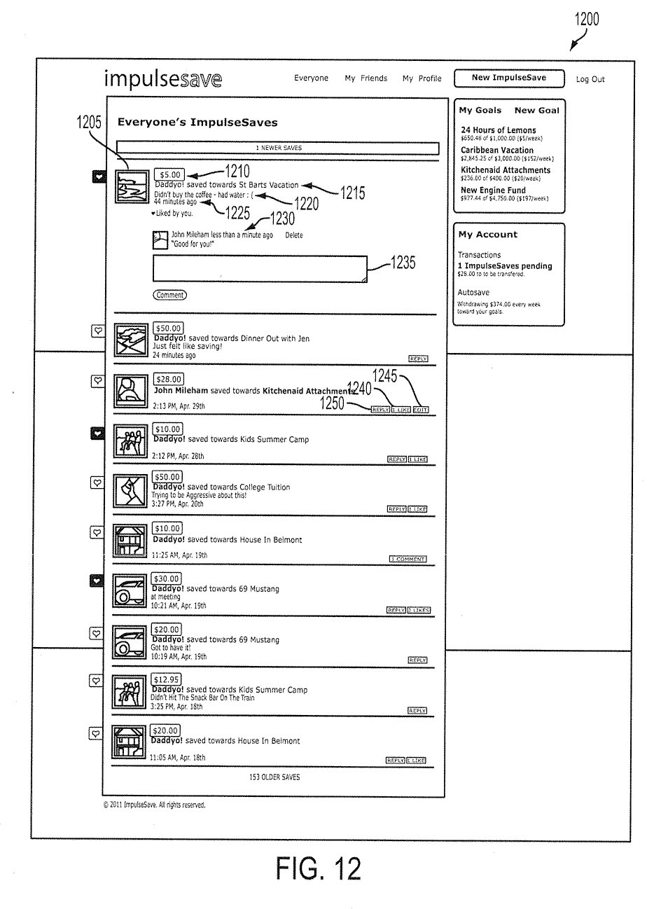

In some embodiments, in step 365, each aspect of the present system, including wish lists, impulse transactions, and lifeline requests motivates further participation by the user, or participation by others. This process of motivating participation will be described in FIG. 12, and will also be described here in an exemplary embodiment.

In some embodiments, each option created in step 355, step 360, or process 1000 motivates encouragement by others, by allowing the consumer to publish a social activity or send a notification to others describing the consumer's decision to use the present system and techniques. An example social activity or notification might say “I saved $19.97 toward my Retirement!”

In step 365, process 305 sends parameters describing the user's decision to use the present system and techniques to social syndication service 233. Example parameters include the product triggering the notification, the amount saved, or the date and time of the user's decision to use the present system and techniques. As described above, social syndication service 233 uses APIs from social network communities 150 to create at least one social activity.

In exemplary embodiments, process 305 uses social syndication service 233 to send a notification of encouragement to the user saying “Good job! Can you do two more today?”

In further embodiments, process 305 uses social syndication service 233 to send the social activity for feedback or encouragement from others in the user's chosen social community on web site 209. An example notification is “Phil just saved $136.65 today toward his House in Belmont. Can you do one?”

Alternatively, social syndication service 233 creates a Facebook® status update or Twitter® tweet announcing “I saved $136.65 toward my House in Belmont!” for encouragement and comments by others in the user's external social network communities 150.

Step 365 of motivating others to participate will be described in further detail in FIG. 12.

### SMS Text Message

As shown in FIG. 3, in some embodiments if mobile device 105 does not have mobile application 200 installed or is not capable of supporting mobile application 200, mobile device 200 allows the consumer to send in step 315 an SMS text message 203 containing a natural language description of the product of interest. A natural language description allows the user to enter a description in his or her native language, rather than requiring stilted or unintuitive computer syntax. An example SMS text message 203 reads “saved $5 on coffee.” SMS text gateway 221 receives SMS text message 203 as input via a short code phone number.

In exemplary embodiments, consumer service 239 defines an analytic formal grammar to describe the types of natural language phrases that SMS text message gateway 221 will recognize. In further embodiments, the analytic formal grammar is a parsing expression grammar (PEG).

Use of PEGs is known in the art to have an advantage of being computationally faster to parse than ambiguous grammars. An example of an ambiguous grammar is a context-free grammar (CFG). This speed is because PEGs have exactly one deterministic parse tree, whereas ambiguous grammars have a nondeterministic parse tree. This advantage makes PEGs well-suited to parsing computer programming languages, but not natural language strings generally.

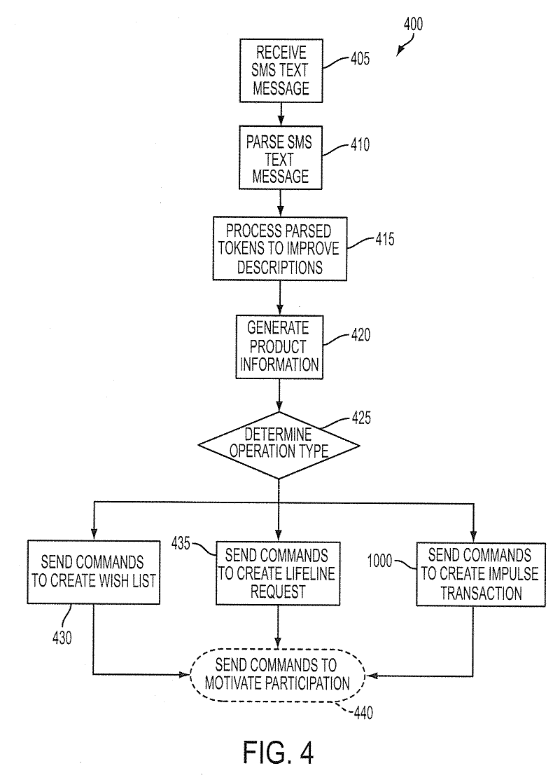

As shown in FIG. 4, process 400 allows consumer service 239 to parse SMS text message 203 from the consumer.

In step 405, SMS text message gateway 221 receives from mobile device 105 an SMS text message 203 containing a description of an impulse transaction along with product information. For example, a consumer sends the SMS text message: “saved $15 on new shoes with coupon at foot locker toward aruba.” Consumer service 239 receives SMS text message 269 from SMS text message gateway 221.

In step 410, according to parsing methods known in the art, consumer service 239 parses the example text message to output an amount of $15, and the following phrases: “on new shoes,” “with coupon,” “toward aruba,” and “at foot locker.” Consumer service 239 uses parser libraries known in the art to define the relevant PEG and parse SMS text message 203. Consumer service 239 then processes the output of these parser libraries to infer that the phrases apply to the following information about an impulse transaction: a title of “on new shoes,” a savings method description of “with coupon,” a financial goal of “toward aruba,” and a location of “at foot locker.” A well-specified grammar allows SMS text message gateway 221 or consumer service 239 to recognize a large range of phrase boundary tokens such as “on,” “with,” “toward,” and “at.”

In step 415, consumer service 239 runs post-processing on the phrases returned by the parser library to improve their descriptions. When executing this post-processing step on the example above, consumer service 239 might process the phrase “on new shoes” to configure a more user-friendly title of “new shoes,” the phrase “with coupon” to configure a more user-friendly savings method description of “coupon,” the phrase “toward aruba” to find and associate the impulse transaction with a financial goal named “Vacation in Aruba,” and the phrase “at foot locker” to configure a more user-friendly location of “foot locker.”

In step 420, consumer service 239 uses this information to generate product information regarding the consumer's product of interest. In step 425, consumer service 239 parses SMS text message 203 to determine the desired operation type. Based on the desired operation type determined in step 425 and product of interest determined in step 420, consumer service 239 creates (1) a wish list in step 430 containing the product, (2) a lifeline request in step 435 describing the product, or (3) an impulse transaction in process 1000 about the product. Impulse transactions, wish lists, and lifeline requests are described in further detail below.

In step 440, consumer service 239 motivates further participation by the user or participation by others. This motivation is further described in FIG. 12.

In a further embodiment, consumer service 239 combines the location returned by parsing the SMS text message with the GPS location information supported by mobile device 105, described above.

### Location-Based Marketing

In a further embodiment, mobile application 200 uses the GPS location capability of mobile device 105 to communicate the user's physical location to consumer service 239. Based on the user's location, consumer service 239 initiates notifications encouraging and reminding the user to initiate impulse transactions according to process 1000 or to use the other social communication features including at least wish lists and lifeline requests. In further example embodiments, consumer service 239 creates automatic notifications to the user in the form of merchant offers such as discounts, coupons, or sponsored or unsponsored challenges. Mobile application 200 further allows the user to set privacy preferences regarding use of the GPS capability of mobile device 105.

### Debit Card

In another embodiment, the user requests to have a credit, debit, or pre-paid card issued for use in shopping at physical retail sites or online. The card is associated with the user's financial account opened by financial institutional partners of the present system.

Web site 209 or mobile application 200 allows the user to associate debit card purchases with triggered impulse transactions. Triggered impulse transactions are described in further detail below. As financial transaction service 236 receives financial transactions made with the card, consumer service 239 triggers a related impulse transaction to transfer an amount based on the purchase amount from an origin financial account into a separate destination financial account. The amount to be transferred may be a (1) percentage of the purchase price, (2) set amount for every transaction, or (3) matching amount of the entire purchase price.

In some embodiments, the consumer elects to be charged more by the merchant, and have the amount of overpayment applied to the destination account.

### Online Example Product Purchase

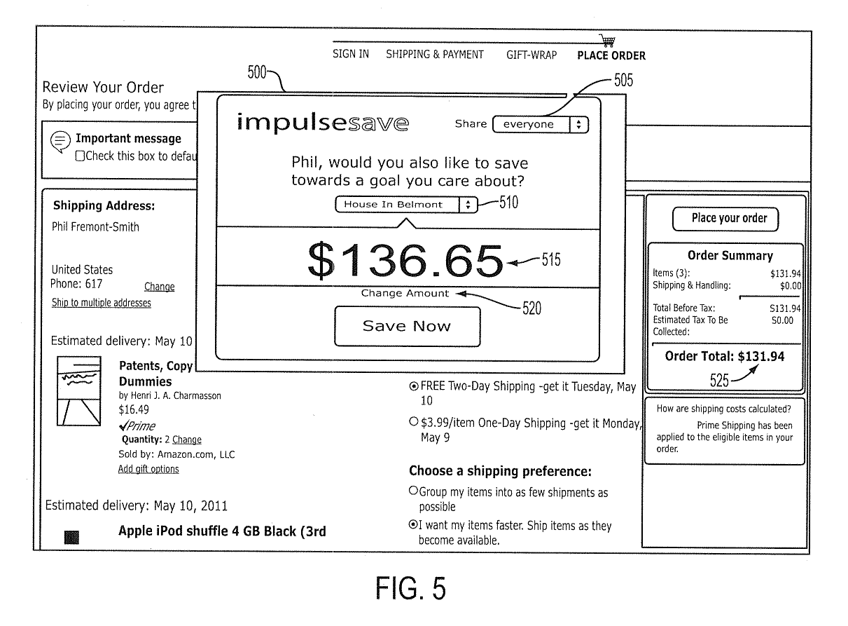

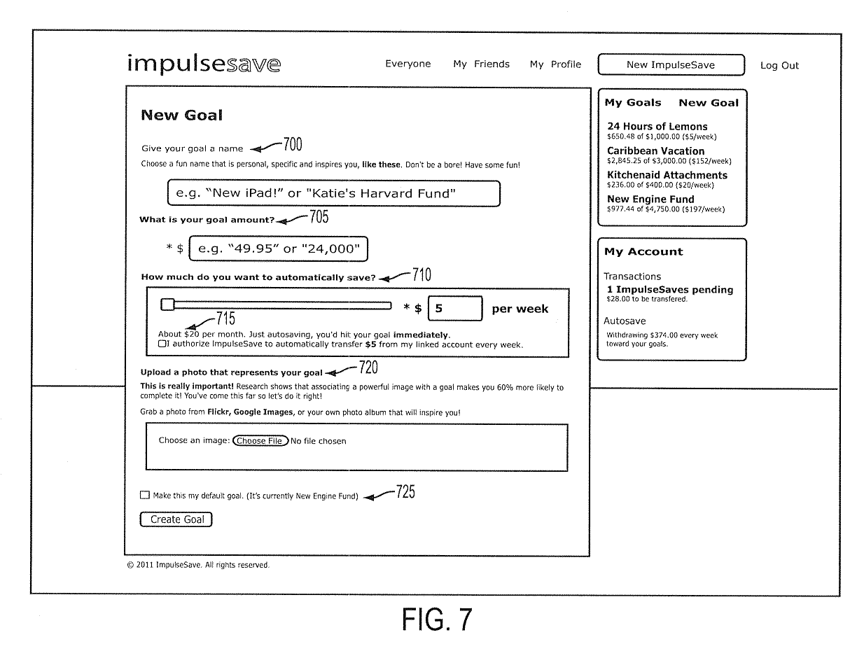

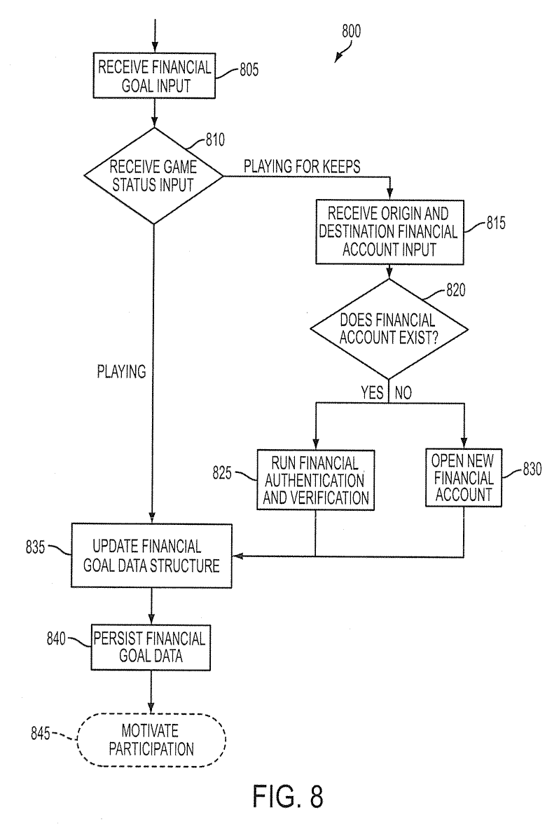

As shown in FIG. 5, in some embodiments as a consumer is shopping online, the consumer uses a consumer device such as web browser add-on 206 to interact with the present system and techniques. When the user is shopping online at an e-commerce site and elects to complete his or her purchase, browser add-on 206 displays a window or notification 500 showing the total amount 515 the user is about to spend and encouraging the user to put money toward more constructive uses than spending. Browser add-on 206 determines when to display the window using heuristics such as content inspection along with Uniform Resource Locator (URL) comparisons to determine both that the consumer is at an e-commerce site, and also the stage of the check-out process for the consumer. These URL comparisons are described in further detail below. As shown in FIG. 5, total amount 515 may be different from but related to the amount 525 shown in the user's e-commerce shopping cart. Browser add-on 206 allows the user to use link 520 to change the amount to apply toward a financial goal 510. Financial goals are described in more detail in FIGS. 7-8. Finally, browser add-on 206 allows the consumer to motivate participation by others, by sharing through drop-down list 505 his decision to apply his money more constructively than impulse spending. As described below, browser add-on 206 allows the user to choose among multiple potential user communities with which to share this information and from which to receive encouragement and incentives.

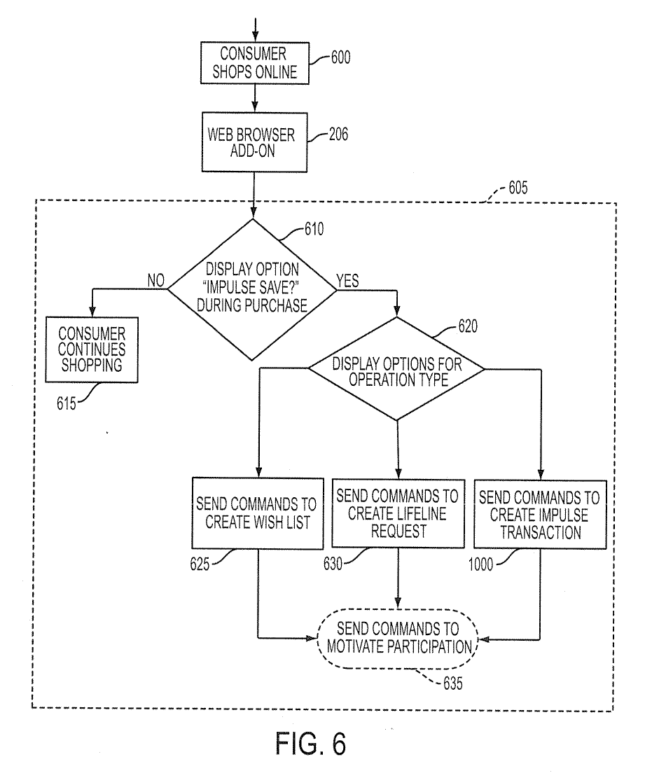

FIG. 6 shows an example embodiment of the present method. In step 610, process 605 includes displaying an option 610 by web browser add-on 206 for a consumer making a purchase to use the present system and techniques. As shown in FIG. 5, display 500 is integrated into the consumer's existing shopping environment online 600. Web browser add-on 206 displays option 610 to use the present system and techniques during the consumer's purchase. Web browser add-on 206 is described in further detail below.

In step 615, if the consumer declines, the purchase completes as usual. In step 620, if the consumer decides to use the present system and techniques, process 605 displays in web browser add-on 206 a set of options. Exemplary options include at least (1) add to wish list in step 625, (2) lifeline in step 630, or (3) impulse transaction in process 1000. Each option is described in further detail below in this description.

In some embodiments, each option displayed in step 620 motivates further participation by the consumer, or participation by interested parties. Step 635 of motivating interested parties to participate will be described in further detail in FIG. 12.

### Internet Browser Add-On

As shown in FIG. 5, web browser add-on 206 allows the consumer to use the present system and techniques in a manner integrated into the user's online shopping experience.

When a user is utilizing computer 110 including the system and techniques of the present invention, web site 209 prompts the user to initiate a browser installation for browser add-on 206.

Once installed, browser add-on 206 presents preference options including at least (1) On or (2) Off. Browser add-on 206 allows the user to control this display through the preference options. For example, the user may choose a preference option of “On,” which indicates to the browser add-on that it is allowed to display the window.

Once installed, browser add-on 206 runs as a background process by the browser. Once the user starts running the browser, browser add-on 206 seeks URL data indicating that the user is currently visiting an e-commerce site. Browser add-on 206 determines whether the user is at an e-commerce site by comparing the browser's current URL to indexed URL patterns available to browser add-on 206. Browser add-on 206 updates this set of indexed URL patterns via consumer service 239 from a datastore of current e-commerce websites. Once browser add-on 206 identifies the user's presence at an e-commerce site and verifies the e-commerce site is indexed, browser add-on 206 encourages the user to use the present system and techniques, for example by displaying window 500 according to process 605.

### Financial Goal Configuration

Before the consumer may participate in the system and techniques described in FIGS. 3-6 and accompanying text, in some embodiments consumer service 239 requires the consumer to configure at least one financial goal.

FIG. 7 shows an exemplary embodiment of web site 209 or mobile application 200 allowing the user to pre-configure at least one financial goal. In the embodiment, web site 209 receives from the user financial goal configuration input data such as a name 700, goal amount 705, optional automatic savings amount 710, and optional photos 720, audio clips, or video clips. Web site 209 or mobile application 200 also displays the amount of long-term savings possible 715 based on automatic savings amount 710.

Web site 209 or mobile application 200 also allows the user to configure a default goal 725. In some embodiments, consumer service 239 uses the default goal, and omits requiring the user to enter financial goal information wherever a goal may be required. This default goal use simplifies the user's required interaction, thereby encouraging and motivating the user to use the present system and techniques to apply his or her money more constructively than impulse spending.

As shown in FIG. 8, consumer service 239 runs process 800 to create a financial goal.

In step 805, web site 209 or mobile application 200 allow the user to create and name financial goals in consumer service 239. As shown in FIG. 7, web site 209 or mobile application 200 represents these financial goals graphically with a goal name 700, description, or one or more photos 720, audio clips, or video clips introducing or explaining the goal. For example, a user may have a goal to save for a car. Web site 209 or mobile application 200 accepts user input including a name of “Toyota Prius,” description of “My dream car!,” and photos or video clips showing the desired car. In some embodiments, web site 209 or mobile application 200 allows the user to make text, audio, photographic and video updates or solicitations for the financial goal through consumer service 239 which updates financial goal datastore 263. Web site 209 or mobile application 200 allows the user to initiate impulse transactions toward these goals in a variety of ways using a variety of client devices.

In step 810, consumer service 239 allows financial goals to be created having possible game statuses. An exemplary status represents at least whether the user's participation in the present system and techniques executes actual financial transactions against at least one financial institution. Another status represents whether the method and system track the user's virtual progress, without executing actual financial transactions. In an exemplary embodiment, a user designates a goal as having the status of (1) Playing, or (2) Playing For Keeps.

In step 815, a status of Playing for Keeps indicates that the user inputs and assigns actual origin and destination financial accounts from which and to which real financial transactions can be directed. Consumer service 239 executes real financial transactions using financial transaction service 236.

For a goal designated as Playing For Keeps, web site 209 or mobile application 200 requires the user to input financial information designating origin financial account(s) and destination financial account(s). Consumer service 239 transacts funds one-way from the originating account to the destination account using financial transaction service 236.

In some embodiments, example origin financial accounts may include bank accounts, retirement, insurance, investment, brokerage, education, debts, charitable donations, and may include rewards or redemption systems. Example destination financial accounts may include bank accounts, investment funds, pre-paid debit or stored value cards, insurance vehicles, creditor accounts or charitable contribution accounts. The destination financial accounts can either be at the same institution or at another distinct institution from the origin financial accounts.

The design of financial data aggregator service 230, financial transaction service 236, and separation of consumer service 239 from financial services 230, 236 keeps the details of these financial accounts secure and private. Consumer service 239 allows only the account owner to see or edit the financial account information.

In step 815, consumer service 239 accepts from the user financial account information representing an origin financial account and a separate destination financial account. If the financial account information represents an existing financial account, consumer service 239 can simply accept the information.

In step 820, consumer service 239 accepts input from the user relating to whether the financial account exists. In step 830, if the origin or destination financial account does not exist, consumer service 239 instructs the financial institution to open a new financial account through financial transaction service 236.

In step 820, if the financial account information is for an existing account, consumer service 239 requires the user to complete an authentication and verification process in step 825 for that account before the account can be actively used. In some embodiments, this verification may include consumer service 239 using financial transaction service 236 to make multiple deposits into the newly entered financial account, and web site 209 or mobile application 200 requiring the user to report on that account activity accurately before consumer service 239 designates the newly entered financial account as active. If any account information is not successfully verified or is left incomplete, web site 209 or mobile application 200 displays the financial account differently from other financial accounts. Consumer service 239 will not allow real financial transactions against the new account until consumer service 239 receives successful authentication and verification processes. In further embodiments, consumer service 239 queues attempted saves until the verification process is complete.

In a further embodiment in the creation or editing of financial goals with a status of Playing for Keeps, consumer service 239 gives the user the option to add or change specific financial account information, for either new or existing financial accounts. The changed financial account information serves as an available financial account for that goal.

Once consumer service 239 accepts a financial account's data, web site 209 or mobile application 200 shows the financial account in the drop-down menu of possible destination accounts.

A financial goal status of Playing means consumer service 239 treats the specific goal for entertainment value alone. Thus, financial transaction service 236 does not execute actual financial transactions toward the specific goal. In some embodiments, every goal's default status is Playing.

In another embodiment, if a user chooses not to associate a financial account with a financial goal by designating the goal as having a status of Playing, web site 209 or mobile application 200 represents the goal in the same manner visually as a Playing For Keeps goal, when impulse transactions are initiated toward the Playing goal.

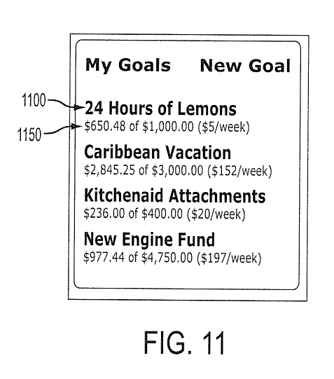

Web site 209 or mobile application 200 also represents progress in a Playing goal as though real financial transactions were executed towards it. Example progress displays are shown in FIG. 11. Where there is no financial account associated with the goal, financial transaction service 236 does not execute financial transactions. Only if consumer service 239 tracks both an origin and destination financial account associated with the goal does consumer service 239 provide the possibility to execute real financial transactions.

Consumer service 239 also allows the goal creator to grant administrator rights to another user.

Web site 209 or mobile application 200 also presents a control panel for each goal, where consumer service 239 allows goal administrators to set preferences, create rules, incentives or timelines, or manage communications with other participants for that specific goal.

In step 835, consumer service 239 updates the financial goal data structures with the information and status input by the user.

In step 840, consumer service 239 persists, or stores, the information in financial goal datastore 260.

In step 845, consumer service 239 allows the user to motivate participation in the financial goal. This step is described in further detail in FIG. 12.

### Organizational Goals

In some embodiments, web site 209 or mobile application 200 allows organizations to seek donations as financial goals. Web site 209 or mobile application 200 allows an organization to create a user account just as individual consumers are able. Web site 209 or mobile application 200 further allows the organization to create a public financial goal page. This public financial goal page allows non-users to participate, even though they have not previously registered a user account with consumer service 239.

One additional benefit of the public nature of this financial goal page is that the organization may publish or syndicate a link or URL to the page on other social network communities 150.

When an invited donor elects to contribute to the organization's financial goal, web site 209 or mobile application 200 may present a minimal subset of fields necessary to register a new user account. Furthermore, web site 209 or mobile site 200 would not require the donor to configure a financial goal or destination financial account of their own.

This registration may include providing information for an origin financial account. Unlike the financial accounts input in step 815, consumer service 239 would not run step 825 of financial authentication and verification against the donor's origin financial account. Instead, the organization would agree that consumer service 239 may use financial transaction service 236 to reverse the financial transaction if the donor's payment bounces or if the donor contests payment.

Once registered, web site 209, mobile application 200, or browser add-on 206 allows the donor to transact funds in support of the organization via impulse transactions, as described in FIGS. 9-10. Therefore, consumer service 239 allows donors to participate in charitable giving in a manner as easy and integrated into their existing lifestyle as impulse spending.

This additional functionality in support of organizations seeking donations is designed to encourage donors to give to the organization in an easily configurable manner. Furthermore, the additional functionality encourages and incentivizes donors to become full users of the present system by initiating step 825 of financial authentication and verification of their origin accounts and by creating their own financial goals according to process 800.

### Impulse Transaction

As shown above in FIGS. 3-6, consumer service 239 allows users to conduct impulse transactions associated with purchases that they would otherwise make anyway. Consumer service 239 associates each impulse transaction with at least one previously configured financial goal. Configuration of financial goals is described above, in connection with FIGS. 7-8.

FIG. 9 shows an exemplary embodiment of web site 209 or mobile application 200 allowing the user to create a new impulse transaction. Web site 209 or mobile application 200 allows the user to enter the method of saving 900, the amount to be transferred 905, the financial goal 910, and social privacy settings 915. Web site 209 or mobile application 200 further allows descriptive comments 930, or links or photos 935.

As shown in FIG. 10, consumer service 239 runs process 1000 to create a new impulse transaction. In step 1005, before submitting an impulse transaction to consumer service 239, web site 209 or mobile application 200 presents a graphical means 910 for the user to identify the intended financial goal to associate with the impulse transaction. From a graphical widget 910 showing financial goals available to the user, web site 209 or mobile application 200 allows the user to associate an impulse transaction with one or more financial goals. Financial goals available to the user include the user's own financial goals as well as any financial goals to which the user has been invited to contribute, and which have been approved by the goal's owner.

As described in FIG. 7, in a further embodiment, web site 209 or mobile application 200 allows users to set a default goal 725 to consumer service 239. If the user then initiates an impulse transaction without specifying a financial goal, consumer service 239 associates the impulse transaction with the default financial goal.

In step 1010, web site 209 or mobile application 200 receives from the user the type of impulse transaction to create. Example types are shown in steps 1015, 1020, and 1025. In some embodiments, available options include initiating the transaction (1) “instead of” purchasing a product, (2) “in addition to” purchasing a product or (3) entirely “independent of” a product or purchase.

In step 1015, if the user chooses an “instead of” impulse transaction, this indicates that the user elects not to buy the product associated with the transaction. Instead, in step 1035, consumer service 239 tracks an amount related to the cost of the unpurchased product. In some embodiments the amount is the full price of the unpurchased product, and in other embodiments the amount is a percentage of the product price.

In a further embodiment shown in step 1030, upon initiation of an “instead of” impulse transaction, consumer service 239 receives input values to create a wish list for storing information relating to the unpurchased product. Supported operations on wish lists include web site 209 or mobile application 200 allowing the user to view, edit, delete, publish via social media, push via social media, comment and re-comment later on the wish list or items therein. In some embodiments, web site 209 or mobile application 200 displays a separate editable wish list for each unpurchased product resulting from an “instead of” impulse transaction.

In step 1020, if the user chooses an “in addition to” impulse transaction, this indicates that the user elects to buy the product associated with the transaction, and also elects to save an amount related to the purchase price of the product. In step 1035, consumer service 239 tracks an amount related to the cost of the purchased product. In some embodiments the amount is a numerical quantity substantially similar to the full purchase price, and in other embodiments the amount is a percentage of the product price.

In step 1025, if the user chooses an “independent of” impulse transaction, this indicates that the user elects to participate in an impulse transaction without associating a potential product with the transaction. In step 1035, consumer service 239 tracks an amount to be saved, which is sent by web site 209 or mobile application 200.

As described in steps 1015, 1020, and 1025 and as shown in step 1035, consumer service 239 calculates an amount to save. Example calculations include deriving a savings amount as a percentage of a purchase price. For an “instead of” or an “in addition to” impulse transaction, the savings amount is related to the purchase price of the product. For an “independent of” impulse transaction, web site 209 or mobile application 200 accepts the savings amount as input from the user or a participant.

In step 1040, consumer service 239 updates the impulse transaction data structures to record the impulse transaction. In some embodiments, example information to record includes the amount saved, time stamp, a unique authorization code for the user, the unique Internet Protocol address or identifier of mobile device 105 or computer 110.

In some embodiments, step 1040 further includes consumer service 239 creating a financial transaction via financial transaction service 236. For example, if the financial goal associated with the impulse transaction has a status of Playing For Keeps, then financial transaction service 236 submits a financial request to transfer the appropriate savings amount from the origin financial account associated with the financial goal into the separate destination financial account associated with the financial goal.

In step 1045, consumer service 239 updates the at least one financial goal associated with the impulse transaction. Consumer service 239 updates the financial goal at least to indicate that the user has increased his or her savings by the amount tracked in the impulse transaction.

In step 1050, consumer service 239 persists the changes to at least one of impulse transactions datastore 260, or financial goals datastore 263.

As shown in FIG. 11, in response to this update, web site 209 or mobile application 200 reflects the savings progress made to the financial goal. Although this exemplary embodiment shows the update as numeric 1150, one of skill in the art will recognize that the presentation may also be graphical.

As described FIG. 12, in a further embodiment, consumer service 239 sends communications to all users related to the financial goal via social syndication service 233. These communications are designed to motivate the user and the user's team interested in motivating the user to apply his or her money more constructively than impulse spending. As a result, web site 209 or mobile application 200 is able to display the updates to all participants allowed to view the goal as described in the goal owner's social privacy settings. These updates will be described in more detail in FIG. 12.

### Triggered Impulse Transaction

The description above has specified how the consumer can create impulse transactions manually. In an alternative embodiment, web site 209 allows the user to create impulse transactions triggered by financial transactions. The financial transactions include at least purchases or other impulse transactions.

In an exemplary embodiment, web site 209 or mobile application 200 allows the user to create a “personal luxury tax” triggered impulse transaction. For example, the user may have a habit of purchasing coffee from a coffee shop. The user decides that, if he or she makes a purchase at the coffee shop over a certain amount such as $5, consumer service 239 will create an impulse transaction to transfer an amount from the pre-configured original financial account into the destination financial account. Alternatively, web site 209 or mobile application 200 allows the consumer to indicate that any purchase at the coffee shop activates a triggered impulse transaction, whether the amount is above or below $5. As with manual impulse transactions, this amount may be a percentage of the financial transaction, or a set amount such as $0.50.

In another exemplary embodiment, web site 209 or mobile application 200 allows the user to configure a “matching funds” triggered impulse transaction. For example, a father and son may both be users of the present system. Web site 209 or mobile application 200 allows the son to create financial goals and create impulse transactions as described above. Web site 209 or mobile application 200 allows the father to create a triggered impulse transaction which deducts a configured amount from the father's origin financial account into the son's destination account. In this manner, consumer service 239 allows the father to match and incentivize impulse transaction activity by the son. As with manual impulse transactions, the matching amount may include at least (1) a percentage of the financial transaction, (2) the entire financial transaction, or (3) a set amount.

Therefore, triggers may be associated with at least (1) financial transactions from particular locations, both retail and online, or (2) other impulse transaction activity from other users.

Web site 209 or mobile application 200 allows the user to control what kinds of financial transactions may be triggered. In this way, web site 209 or mobile application 200 allows the user to configure consumer service 239 to create a new impulse transaction from the origin financial account to any destination financial account upon triggering of a relevant rule. As described above, web site 209 or mobile application 200 further allows the user to specify that impulse transactions should be in a numerical savings amount or a percentage of the purchase price.

In some embodiments, when web site 209 or mobile device 200 allows the user to create impulse transaction rules for a triggered impulse transaction, web site 209 or mobile device 200 stores the rules through consumer service 239 in impulse transactions datastore 260.

To execute the associated financial transaction, consumer service 239 checks impulse transactions datastore 260 for the existence of trigger rules and retrieve the user's financial status using financial data aggregation service 230. Consumer service 239 uses financial transaction service 236 to execute the associated financial transaction either at that time or during a timed financial transaction batch upload procedure by financial data aggregation service 230. Financial transaction service 236 therefore communicates the financial transaction data created from the triggered impulse transaction in its normal course along with other financial transaction data created from other impulse transactions to the financial institutions' servers, and the financial institutions process the financial transactions as part of their normal business processes.

### Point Of Sale Terminal

Point Of Sale terminals 100 are configured to accept consumer methods of payment for purchases at retail. Example forms of payment include at least cash, debit or credit cards, or gift cards.

Although the present system does not require any integration with Point Of Sale terminal 100, the triggered impulse transactions described above allow consumers to put these Point Of Sale retail purchases to constructive uses.

For example, web site 209 or mobile application 200 allows a user to configure a triggered impulse transaction to assess a “personal luxury tax” on every purchase from a coffee shop. The process for configuring this triggered impulse transaction is described above. After this initial configuration, every purchase at the coffee shop Point Of Sale terminal 100 triggers participation in an impulse transaction which allows the consumer to apply funds constructively toward a financial goal. Therefore, the consumer is able to participate in financially beneficial impulse transactions even while he or she is spending at Point Of Sale terminal 100.

### Automatic Impulse Transactions

As shown in FIG. 7, in some embodiments, in addition to impulse transactions entered manually or triggered according to pre-configured rules, web site 209 or mobile application 200 allows the user to configure automatic impulse transactions 710. In automatic impulse transactions, web site 209 or mobile application 200 enables the user to schedule a deduction to occur at regular intervals. At the pre-configured time, consumer service 239 checks impulse transactions datastore 260 for the existence of scheduled transactions and executes the associated financial transaction either at that time or during a timed financial transaction batch upload procedure by financial transaction service 236. Financial transaction service 236 therefore communicates the financial transaction data created from the automatic impulse transaction in its normal course along with other financial transaction data created from other impulse transactions to the financial institutions' servers, and the financial institutions process the financial transactions as part of their normal business processes.

### Wish List

As shown in FIGS. 3-6, in some embodiments while the user is shopping retail or online, consumer service 239 allows the user to add a product to a wish list. For example, in FIG. 3 if a consumer is shopping in a retail setting 300, mobile application 200 enables the consumer to photograph an item in step 320 or scan an item's barcode in step 325 for submission to consumer service 239 to create a wish list in step 355 containing the item.

Consumer service 239 may receive input values relating to the wish list item, including at least a short name, description, and date of addition. In further embodiments, these input values include a financial goal with which to associate the wish list, or a standalone category or name separate from any financial goal.

In some embodiments, web site 209, mobile application 200, or browser add-on 206 receives input values from the user to create a wish list item manually.

As shown in FIGS. 3-6, in some embodiments web site 209, mobile application 200, or browser add-on 206 motivates participation in steps 365, 440, 635 in the activity. This motivation includes displaying notifications to encourage the user or others in the user's community to provide feedback or encouragement over the user's activity of adding the item to the wish list. The process of motivating participation in the user's activity is described in FIG. 12.

### Lifeline

As shown in FIGS. 3-6, in some embodiments while the user is shopping retail or online, web site 209 or mobile application 200 allows the user to use a lifeline in steps 360, 435, 630. A lifeline request allows the user to request encouragement or positive or negative feedback from the user's community on an impulse transaction or potential purchase. Example communities include the entire user community of the present system or a relevant subset thereof, such as the user's friends, or the user's team configured for a financial goal. Example communities also include other social networking sites, such as Facebook®, Twitter®, or LinkedIn®, as retrieved through social syndication service 269. Just as with impulse transactions and wish lists, web site 209 or mobile application 200 allows the user to specify a financial goal, or use the pre-configured default financial goal.

Web site 209, mobile application 200, browser add-on 206, or SMS text message gateway 221 allows the user to input (1) product, (2) cost, (3) current location, or (4) other data including photographs or video, and select recipients for distribution. Web site 209, mobile application 200, browser add-on 206, or SMS text message gateway 221 allows the user to submit the lifeline 360, 435, 630 for distribution by consumer service 239 to the user's friends, the entire user community of the present system, or a larger community using social syndication service 269 to other social networking communities 150 such as Facebook® and Twitter®.

Web site 209, mobile application 200, browser add-on 206, or SMS text message gateway 221 submits the relevant data as input to consumer service 239 for the recipients' own web sites 209 or mobile applications 200 to render. As shown in FIG. 3, mobile application 200 submits the relevant data through mobile API 218. As shown in FIG. 4, SMS text message gateway 221 parses SMS text message 203 and submits the identified tokens to consumer service 239 for processing. As shown in FIG. 6, web site 209 or browser add-on 206 submits the relevant data through consumer API 224.

In further embodiments, consumer service 239 pushes a notification inviting the recipients to login to web site 209 or mobile application 200 and see the user's lifeline request.

Web site 209 or mobile application 200 allows the recipients to respond in real-time to the user's lifeline request. In an exemplary embodiment, such responses are in the form of support not to give in to temptation. These responses therefore represent encouragement for the consumer to apply his or her money more constructively than impulse spending. Consumer service 239 accepts these responses from web site 209 or mobile application 200 and publishes or pushes these responses as notifications to the user's community.

In some embodiments, web site 209 or mobile application 200 also allows the user to select lifelines for public viewing by the user community of the present system. Web site 209 displays selected lifelines (1) in a real time activity scroll of such requests, or (2) in users' online accounts. Mobile application 200 displays selected lifelines as mobile notifications on mobile device 105.

Web site 209 displays answers or responses from recipients in the submitter's online account and on the lifeline page accessible within each user's online account. Mobile application 200 displays answers or responses as mobile notifications on mobile device 105. Web site 209 or mobile application 200 allows the user to configure a time limit for lifeline requests before the requests are cleared in order to avoid the user or mobile application 200 from becoming overwhelmed with responses that are no longer relevant. However, web site 209 continues to make available the ticker scroll of lifeline requests and responses.

### Motivating Participation

In step 365 of process 305, step 440 of process 400, and step 635 of process 605, in some embodiments consumer service 239 optionally motivates participation both from users and from others. This motivation includes both encouragement and incentives, both for the user and for others in the user's designated community. These encouragement and incentives combine to create additional and increased cycles of applying money more constructively than impulse spending.

### Example Interaction

In step 440 of process 400, in some embodiments consumer service 239 optionally encourages and invites participation in a user's financial goal. For example, a user invites others to participate in the user's financial goal. This invitation process is described in further detail below.

Once web site 209 or mobile application 200 receives acceptance by an invitation recipient of the user's financial goal, web site 209 or mobile application 200 displays the user's financial goal and progress thereon in the recipient's online account.

As shown in FIG. 12, in an exemplary embodiment web site 209 or mobile application 200 allows the user to view historical lists 1200 of (1) the user's own impulse transactions, (2) impulse transactions made by the user's friends, and (3) impulse transactions made by the user community at large of the present system. List 1200 shows an example of impulse transactions made by the user community at large of the present system. For example, item 1215 shows that user Daddyo! has saved towards his financial goal named St Barts Vacation.

In presenting historical lists 1200, web site 209 or mobile application 200 displays a goal name 1215, amount saved 1210, descriptive comment 1220, and date and time 1225. Web site 209 or mobile application 200 also allows users to view widgets 1205 such as photos, links, comments, or video posted within an impulse transaction by other originators or from the user community. Web site 209 or mobile site 200 also displays encouragement 1230 from other users.

Web site 209 or mobile application 200 allows the user to select any of these listed impulse transactions, and web site 209 or mobile application 200 allows the user to view more information including a comment box 1235, designed to encourage the user to enter a comment on the impulse transaction. When web site 209 or mobile application 200 receives the user's submission of this comment, consumer service 239 generates social notifications to all users associated with the financial goal. Web site 209 or mobile application 200 allows all users associated with the financial goal to access and read the commenter's comments or other data within their own accounts.

In some embodiments, web site 209 displays from the home page or within the user's account a ticker scroll of real-time activity including impulse transactions or lifeline requests retrieved via consumer service 239 from impulse transactions datastore 260. In further embodiments, web site 209 displays a subset of recent events in loosely chronological order based on relevance factors. Example relevance factors may include privacy preferences of the event's originator, the relationship of the event originator to the viewer as retrieved from user profiles datastore 257 or user social activity datastore 254, and scoring business logic based on relevance to the viewer.

### Configuring Social Community

Once a financial goal is created as described in FIGS. 7-8, in some embodiments consumer service 239 encourages the user to invite others to participate in the financial goal. The team of invitees may include users and non-users. Web site 209 or mobile application 200 allows the user to search and select individuals from consumer service 239. Consumer service 239 also uses social syndication service 233 to search other social networks at which the user holds accounts.

If a recipient of an invitation is a new user, consumer service 239 allows the user to invite individuals via email or other communications means to register a new user profile at web site 209 and to participate in the specific financial goal. If the recipient is an existing user, web site 209 or mobile application 200 displays the invitation request graphically in the recipient's user account. These requests encourage the recipient to view the financial goal and its corresponding text, audio, photographic or video descriptions and updates, and to accept the request to participate in the financial goal. Once initiated, these invitations are also conveyed via various social notifications to the recipient. These social notifications prompt the recipient to log in to his or her own account or create an account if the recipient is a new user, view any related content, and accept or decline the invitation to participate in the financial goal.

If a recipient accepts the user's request to participate in a financial goal, web site 209 or mobile application 200 displays the financial goal within the recipient's menu of possible financial goals, and allows the recipient to contribute transactions towards the financial goal.

In other embodiments, web site 209 or mobile application 200 allows the user to see and search for “friends” who are also registered, separate from any financial goal or impulse transaction. Web site 209 or mobile application 200 allows the user to link his or her account profile to his or her friends' account profiles. Web site 209 or mobile application 200 shows as friends those whom the user chooses to invite and accept and who have invited and accepted the user. Web site 209 or mobile application 200 allows the user to remove friends and invite new friends from within the user's account.

### Motivating Further Participation by the User

Once the user participates in an impulse transaction, sends a lifeline request, or adds a product to a wish list, in some embodiments consumer service 239 optionally encourages or incentivizes further participation by the user.

In some embodiments, if the user creates an impulse transaction, consumer service 239 sends notifications of encouragement to the user. Example notifications include “Good job, you're $5 closer to your Dream Car!” or “Well done, you're now $10 closer to your Vacation in Aruba!” Further examples of encouraging phrases include “You're a smart saver!,” “You're gettin' there!,” “Ka-ching!,” “All right!,” “You Rock!,” “Great job!,” “Fantastic!,” “You should be stoked!,” “You're on fire!,” “Woot woot!,” “Love it!,” “Bam!,” “Aww snap!,” “Boom!,” “Score!,” “Booya!,” “Nice!,” “Aww Yeah!,” “You're a natural!,” “Wowzah!,” “Sweet!,” “Schweeet!!,” “Rock on!,” “Right on!,” “Niiice!,” “Yahooo!,” “Yayyyy!,” or “Cool!”

In further embodiments, consumer service 239 tracks the number of impulse transactions performed by the user over a period of time. Consumer service 239 therefore sends notifications encouraging further participation to the user. For example, consumer service 239 sends a notification encouraging further participation such as “Can you do two more today?” Further examples of follow up phrases include “Can you save again today?,” “Keep it up!,” “Can you do another?,” “Any friends who could help you save?,” “Go for one more!,” “Try to break your record!,” “How many more can you do today?,” “Do another one right away!,” “Keep saving!,” or “Keep on keepin' on!”

In additional embodiments, if the user creates a lifeline request or adds a product to a wish list, consumer service 239 sends notifications of encouragement to the user. Web site 209 or mobile application 200 displays encouragement notices related to the wish list or lifeline. For example, consumer service 239 sends encouragement notifications to the user to wait before purchasing a product or service tracked in a lifeline request. Web site 209 or mobile application 200 displays these notifications of encouragement to the user. Content service 239 syndicates, or distributes, this content to social networks of which the user is a member, including at least Facebook®, Twitter®, or a weblog associated with web site 209.

In other embodiments, web site 209 or mobile application 200 encourages users to share stories of impulse transactions and participate in ongoing conversations on the subject. In example embodiments, web site 209 encourages sharing and participation within the online account via a form requesting these stories, or via a notification shown in mobile application 200 or mobile device 105. Content service 239 then syndicates or distributes this content to social networks of which the user is a member, including at least Facebook®, Twitter®, or a weblog associated with web site 209.

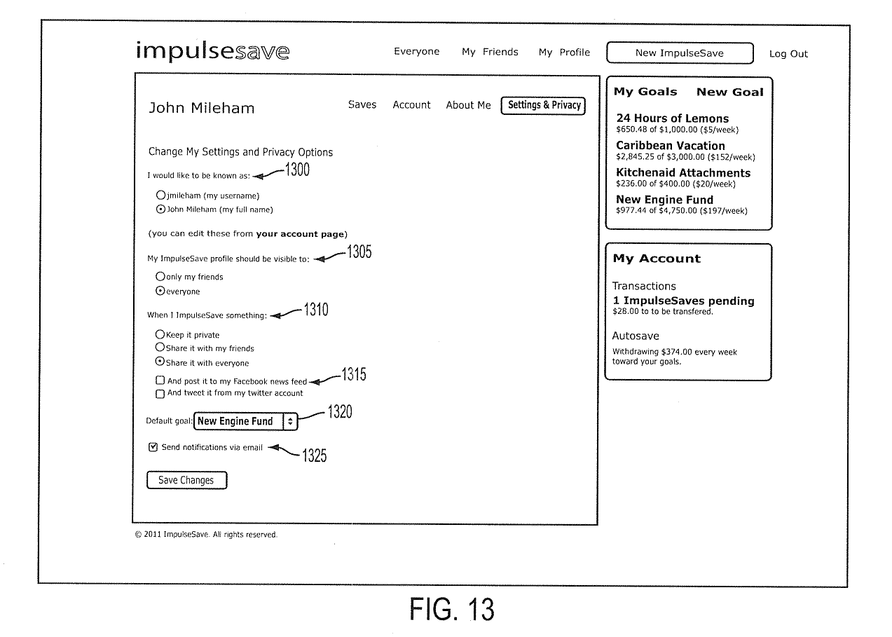

In further embodiments, consumer service 239 first retrieves the user's default social privacy preferences to verify whether the user has chosen for syndication to happen automatically. These social privacy preferences are described in further detail in FIG. 13. In some embodiments, web site 209 or mobile application 200 allows the user to modify or override the default social privacy preferences with specific decisions on whether to syndicate or distribute a specific social notification. For example, web site 125 or mobile application 200 displays a “Share This” link for the user to indicate approval for consumer service 239 to submit the social data as input to social syndication service 269.

In another embodiment, web site 209 or mobile application 200 allows the user to choose to syndicate an impulse transaction to a social network after web site 209 or mobile application 200 have displayed the impulse transaction in the user's history list.

If the user chooses to initiate an impulse transaction, the data associated with the transaction may be (a) displayed as a historic event within the user's online account or (b) published or pushed to social networks according to the user's social privacy preferences. As described below, the user's social privacy preferences may include options for the notification to be distributed to the entire user community of the present system, to only the user's friends, to other social networking platforms 150 such as Facebook® and Twitter®, or kept private to the user's own online account. As shown in FIG. 13, in some embodiments consumer service 239 allows users to set default privacy preferences. Consumer service 239 allows users to modify or override these default preferences per impulse transaction or per social activity.

### Motivating Participation by Others

Once the user participates in an impulse transaction, sends a lifeline request, or adds a product to a wish list, in some embodiments consumer service 239 optionally encourages or incentivizes participation by others in the user's community. This motivation is shown in step 365 of process 305, step 440 of process 400, and step 635 of process 605. The user's community includes (1) the team of invitees designated by the user for a particular financial goal; (2) all friends added by the user across all of the user's financial goals, or unconnected with any financial goal; or (3) the public user community of the present system.

In some embodiments, if the user creates an impulse transaction, consumer service 239 sends notifications of encouragement to the user's community. Example notifications include “Bob is $5 closer to his Dream Car!” or “Jane saved $10 toward her Vacation!”

As is apparent in FIG. 12, one of skill in the art will recognize that web page 209 or mobile application 200 are not limited to text visualizations as described above, and may instead use many different visualization means to present the user's progress to the user's community.

In further embodiments, consumer service 239 tracks the number of impulse transactions performed by others in the user's community over a period of time. Consumer service 239 then sends notifications encouraging further participation to the user's community. For example, consumer service 239 sends a notification encouraging participation such as “Can you do two today yourself?”

### Incentivizing Participation by Users or by Others

In further embodiments of motivating participation by users or by others, web site 209 or mobile application 200 encourages or incentivizes participation through challenges and games.

### Challenges

In some embodiments, consumer service 239 sends “challenges” to the user and to others as one form of incentivizing the user to apply his or her money more constructively than impulse spending. Challenges may be specific messages or notifications to participate in an impulse transaction.

Web site 209 or mobile application 200 may display challenges from (1) the corporate team, (2) friends of the user, (3) the user's team of invitees as designated in the user's financial goals, (4) merchants sponsoring a challenge, or (5) the entire user community of the present system. Web site 209 or mobile application 200 may display challenges in the user's online account in a communications box or window, or via social notifications. Social notifications include email reminders, SMS text messages, announcements, or postings to social networks to login to web site 209 or mobile application 200 when a new challenge has been posted. Web site 209 or mobile application 200 allows the user to control participation in and notification of challenges via the user's social privacy preferences.

In further embodiments, a sponsoring merchant or other contributor might decide to incentivize participation in a challenge. In one exemplary embodiment, merchant web site 212 allows a merchant to sponsor a fund matching campaign, whereby merchant web site 212 allows the merchant to designate contributing funds in a matching amount towards a participant in the challenge. The merchant's action incentivizes participation in the challenge by the user community. Encouraging or incentivizing participation in the challenge therefore motivates the user to apply his or her money more constructively than impulse spending.

### Games

Consumer service 239 also offers games to incentivize users and their communities to participate in impulse transactions. These games may last for a specified duration.

In an exemplary embodiment, consumer service 239 offers a “matching funds” game in which consumer service 239 matches an amount saved via impulse transaction by a user chosen at random for a given time period.

In another exemplary embodiment, web site 209 or mobile application 200 allows the user to create a game using consumer service 239. The game is named “hot potato.” In this game, web site 209 or mobile application 200 allows the user to make an impulse transaction within a time limit tracked by consumer service 239. Web site 209 or mobile application 200 then requires the user to designate another user. Consumer service 239 restarts the timer and the game requires the new user to make an impulse transaction within the time limit. Web site 209 or mobile application 200 allows the user to configure the hot potato game to be played in teams or individually. If consumer service 239 does not receive an impulse transaction from a user before the time limit expires, the game is over for the user or for the user's team.

In further embodiments, consumer service 239 enforces optional rules to keep the game fair. For example, consumer service 239 requires a minimum amount saved in the impulse transaction before allowing the user to designate a new user, or “pass the hot potato.” Alternatively, consumer service 239 tracks whether users are simply designating one other user back and forth, or “passing the hot potato back and forth.”

In some embodiments, consumer service 239 uses metrics to evaluate a user's success in the game. Example metrics include at least evaluating which team was able to complete the largest quantity of impulse transactions. The team having the longest “chain” of impulse transactions would therefore win. Other example metrics include evaluating which team was able to save the largest amount of money, regardless of the quantity of impulse transactions.

In further embodiments, web site 212 allows merchants sponsoring the game or the owners or administrators of the present system and techniques to reward the winners through consumer service 239. As one reward, web site 209 or mobile application 200 displays a leaderboard. Alternatively, a team winning a game for an organizational financial goal receives a matching donation from a merchant sponsor or from the administrator or owner of the present system and techniques. Organizational financial goals are described in further detail above.

Used in this manner, such games motivate users to create impulse transactions, thereby putting their money to more constructive uses than impulse spending.

### Social Privacy Settings

As shown in FIG. 13, in some embodiments web site 209 or mobile application 200 allows the user to configure social privacy preferences. In an exemplary embodiment, web site 209 or mobile application 200 allows the user to configure a display name 1300, public or private visibility of the user's account profile 1305, or public or private visibility of the user's impulse transactions 1310. As described above, public or private visibility 1305, 1310 may include visibility to (1) only the user, (2) all friends added by the user across all of the user's financial goals, or unconnected with any financial goal; or (3) the public user community of the present system.

In a further embodiment, web site 209 or mobile application 200 allows the user to configure whether consumer service 239 will create the social notifications and publications described above on social networking communities 150 using social syndication service 233. Furthermore, web site 209 or mobile application 200 allows the user to configure the communication means 1325 used to send social notifications. As described above, exemplary forms may include email reminders, SMS text messages, announcements, or postings to social networks.

Furthermore, also as described in FIG. 7 above, in some embodiments web site 209 or mobile application 200 allows the user to configure a default financial goal 1320. As described above, this functionality therefore allows the user to omit sending financial goal input values any time a financial goal is required. Instead, consumer service 239 retrieves the user's default financial goal from financial goal datastore 263.

### Contextual Recommendations

In some embodiments, a recommendation engine of the present invention running on consumer service 239 collects, analyzes and utilizes key data points pertaining to different static and variable aspects of the user's life. Example variable data points include data specific to the user's life and events happening in the user's life at a given time. Example variable data points include at least the user's psychometric data from psychometric surveys, momentary sentiment analysis, national and regional survey data, habitual spending trend analysis for the user or across the user's social graph, social context for spending nationally or individually for the user, time of day, seasonal environments, weather conditions, retail and online traffic, regional or national population distribution, or movement including transportation traffic, retail traffic, real-time trends in news or search or social media keywords or real-time regional or national pricing or sale or discount data.

From placing the user into this extensive contextual perspective, the recommendation engine utilizes these data points to calculate a 360 degree perspective on the user's likely impulses and appetites for certain behavior at certain times and environments under certain conditions and contexts. The recommendation engine produces a ratio or index of likely consumption versus savings behavior.

In addition to contextual analysis of the user, the recommendation engine rates appropriateness for the user of financial or other products, based on key factors. Exemplary key factors include (1) psychometric, financial, actuarial or statistical factors, (2) personal risk tolerance, (3) financial transaction velocity (frequency of purchases or savings financial transactions, or size of financial transactions into destination financial accounts), (4) consumption data, or (5) urgency rating. In an exemplary embodiment, the user's urgency rating is determined by factors including at least the user's age, expected annual income before retirement, the user's current and expected debt, or environmental factors including inflationary or recessionary economic factors.

Therefore the recommendation engine may (1) recommend specific products, financial or other, calculated to be worthy of the user's consideration from a financial perspective, or (2) warn or discourage the user from products and behaviors calculated to be “unworthy” from a financial perspective.

Specific to the ongoing psychometric survey, in some embodiments web site 209 or mobile application 200 presents questions, for example through a window at certain times throughout the user experience within the user's online account. Ultimately web site 209 displays a series of web pages to survey the user on the contextual factors described above. Web site 209 then receives from the recommendation engine a contextual analysis. In a further embodiment, the contextual analysis may include appropriate product recommendations from merchants.

In another aspect, web site 209 or mobile application 200 encourages the user to share the resulting recommended products across the user's community. Example recipients include the user's friends retrieved from consumer service 239, or the full user community for the present system and techniques. Web site 209 or mobile application 200 further encourages the user to create social notifications for the user's social networks 150.

### Merchant Interaction

In another embodiment, web site 209 or mobile application 200 allows the user to choose to see money-saving or other offers, deals or promotions from merchants or financial institutions. Web site 209 or mobile application 200 allows the user to opt in to be contacted by sellers of targeted or relevant products, or opt out from being contacted. Web site 209 or mobile application 200 allows the user to use a lifeline to request feedback on recommended products via consumer service 239.

In a further embodiment, web site 209 or mobile application 200 allows users to take merchant-sponsored surveys. Upon completion of the surveys, web site 209 or mobile application 200 allows the user to accept a donation to at least one financial goal, or payment in another form such as a value card or coupon.

In some embodiments, merchant web site 212 allows third party merchants to access merchant service 242 through their own user profiles. Merchant web site 212 allows merchants to (1) sponsor challenges to the whole community or to segments of the community made available through a data searching module, (2) enter competitive offers from their institutions for banking, insurance, financial or other products, (3) offer surveys to be completed by consumers, (4) design and execute targeted advertising to be seen by the users who have opted in to see it, via a series of audience analysis and reporting tools and ad placement and campaign analysis tools. Consumer web site 209 retrieves users' opt-in preferences through consumer service 239 before displaying merchants' recommended products.

As will be apparent to one of ordinary skill in the art from a reading of this disclosure, the disclosed subject matter can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. The examples below describe ways in which the embodiments may be tailored to be different. The scope of the invention is as set forth in the appended claims and equivalents thereof, rather than being limited to the examples contained in the foregoing description.

Various embodiments of the systems and techniques described here can be realized in digital electronic circuitry, integrated circuitry, specially designed application specific integrated circuits (ASICs), computer hardware, firmware, software, or combinations thereof. These various embodiments can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

To provide for interaction with a user, the systems and techniques described here can be implemented on a computer having a display device (e.g., a cathode ray tube (CRT) or liquid crystal display (LCD) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few embodiments have been described in detail above, other modifications are possible. The systems and methods described herein may be implemented in many different mobile device networks, including by way of example, cellular voice networks; wide area wireless networks such as TDMA, CDMA, W-CDMA, GSM, satellite-based, or EDGE networks; metro area networks such as WiMAX networks; local area networks such as WiFi networks; or any other wireless networks that can deliver voice, data, information, gaming applications, business or utility applications, or other services over a large or small geographical area. Also, the logic flows depicted in the figures may not require the particular order shown, or sequential order, to achieve desirable results. Other steps may be provided, or steps may be eliminated, from the described flows, and other components may be added to, or removed from, the described systems. Accordingly, other implementations are within the scope of the method and system.

What is claimed is:

1. A system for motivating users toward at least one constructive financial alternative to spending, the system comprising:
a memory capable of storing data; and
a server operable to communicate with at least one consumer device and memory, said server configured for:
receiving, at said server, from one of said at least one consumer device, an initial configuration for at least one financial goal, wherein said configuration includes a goal name and a target amount representing a financial value associated with said at least one financial goal;
receiving, at said server, from one of said at least one consumer device, an electronic command selecting an option representing a choice from among a plurality of spending options integrated into a user's lifestyle and spending patterns, to direct an application of funds of a given amount benefiting said at least one financial goal.

2. The system of claim 1, wherein said server is further configured for sending, to interested participants, electronic notifications configurable to motivate participation toward achieving said at least one financial goal.

3. The system of claim 2, wherein said interested participants include said user.

4. The system of claim 2, wherein said server is further configured for receiving designations from said user of other users interested in said at least one financial goal, and wherein said interested participants include said other users.

5. The system of claim 2, wherein said electronic notifications configurable to motivate participation include electronic updates sent to said at least one consumer device sufficient to display an updated progress of said user toward achieving said at least one financial goal.

6. The system of claim 2, wherein said electronic notifications configurable to motivate participation include sending to said at least one consumer device motivational responses encouraging or incentivizing said user to participate in additional transactions to direct potential application of more funds of a given amount benefiting said at least one financial goal, representing a choice from among a plurality of spending options integrated into said user's lifestyle and spending patterns.

7. The system of claim 4, wherein said electronic command comprises sending an electronic notification configurable to seek feedback or encouragement from said other users regarding a potential purchase.

8. The system of claim 1, wherein said electronic command causes said server to add information about a potential purchase to a wish list of potential purchases.

9. The system of claim 1, wherein said initial configuration for said at least one financial goal further comprises information to associate with said at least one financial goal at least one origin financial account and at least one destination financial account separate from said at least one origin financial account.

10. The system of claim 9, wherein said electronic command directs an actual transfer of funds benefiting the at least one financial goal from the at least one origin financial account into the at least one destination financial account.

11. The system of claim 4, wherein said electronic notifications configurable to motivate participation from interested participants include notifications to social networking communities describing said user's updated progress.

12. A computer-implemented method of motivating users toward at least one constructive financial alternative to spending, the method comprising:
receiving, at a server, from a user, an initial configuration for at least one financial goal, wherein said configuration includes a goal name and a target amount representing a financial value associated with the at least one constructive financial alternative to spending;
receiving, at said server, from said user after said initial configuration is complete, an electronic command directing potential application of funds of a given amount benefiting said at least one financial goal, representing a choice from among a plurality of spending options integrated into said user's lifestyle and spending patterns.

13. The method of claim 12, further comprising the step of sending, to interested participants, electronic notifications configurable to motivate participation toward achieving said at least one financial goal.

14. The method of claim 13, wherein said interested participants include said user.

15. The method of claim 13, further comprising the step of receiving designations from said user of other users interested in participating in said at least one financial goal, and wherein said interested participants include said other users.

16. The method of claim 13, wherein said electronic notifications configurable to motivate participation include electronic updates sent to at least one consumer device sufficient to display an updated progress of said user toward achieving said at least one financial goal.

17. The method of claim 13, wherein said electronic notifications configurable to motivate participation include sending to at least one consumer device motivational responses encouraging or incentivizing said user to participate in additional transactions to direct potential application of more funds of a given amount benefiting said at least one financial goal, representing a choice from among a plurality of spending options integrated into said user's lifestyle and spending patterns.

18. The method of claim 15, wherein said electronic command comprises sending an electronic notification configurable to seek feedback or encouragement from said other users regarding a potential purchase.

19. The method of claim 12, wherein said electronic command causes said server to add information about a potential purchase to a wish list of potential purchases.

20. The method of claim 12, wherein said initial configuration for said at least one financial goal further comprises information to associate with said at least one financial goal at least one origin financial account and at least one destination financial account separate from said at least one origin financial account.

21. The method of claim 20, wherein said electronic command directs an actual transfer of funds benefiting said at least one financial goal from said at least one origin financial account into said at least one destination financial account.

22. The method of claim 15, wherein said electronic notifications configurable to motivate participation from interested participants include notifications to social networking communities describing said user's updated progress.

23. A computer-implemented method of motivating users toward at least one pre-configured financial goal, the pre-configured financial goal representing a constructive financial alternative to spending, and including a goal name and target amount representing a financial value associated with the at least one pre-configured financial goal, the method comprising:
receiving, at a server, from a user at a consumer device, an electronic command directing potential application of funds of a given amount benefiting the at least one pre-configured financial alternative to spending, representing a choice from among a plurality of spending options integrated into said user's lifestyle and spending patterns; and
sending, to interested participants, electronic notifications configurable to motivate participation toward achieving the at least one pre-configured financial goal.
